(19) United States
(12) Patent Application Publication
(10) Pub. No.: US 2022/0299212 A1
(43) Pub. Date: Sep. 22, 2022

(54) Heating Panels and connection methods thereof

(71) Applicant: Shalom Wertsberger, Penfield, NY (US)

(72) Inventor: Shalom Wertsberger, Penfield, NY (US)

(21) Appl. No.: 17/695,530

(22) Filed: Mar. 15, 2022

Related U.S. Application Data
(60) Provisional application No. 63/310,768, filed on Feb. 16, 2022.
(60) Provisional application No. 63/216,518, filed on Jun. 29, 2021.
(60) Provisional application No. 63/162,445, filed on Mar. 17, 2021.

(51) Int. Cl. F24D 13/02; E04F 15/02; H05B 1/02

(52) U.S. Cl. CPC F24D 13/024; E04F 15/02038; E04F 15/02016; H05B 1/0277; E04F 2201/0138; E04F 2201/023; E04F 2201/043; E04F 2290/023; H05B 2203/016

(57) ABSTRACT

A floor panel having a heating element disposed therein, the floor panel having at least two abutments for operationally coupling the panel to adjacent panels. Electrical contacts are disposed on complementary abutments or abutment walls and busbars electrically couple between complementary contacts of opposing abutments such that, when adjacent floor panels are laid together to form a floor or a portion thereof, the busbars are able to feed power to heating elements disposed in the panel. The panel have sealants and/or adhesives which protect at least one contact from fluids. Also disclosed are connector bars, adapters, and switching and protection arrangements, and optional constructions for inter-panel connectors.

### FIELD OF THE INVENTION

The present invention relates generally to heating panels such as floor panels or tiles, wall tiles and the like, and more specifically to heating panels with overlapping portions utilized connecting the panels as well as for providing electrical connection to the panel.

### BACKGROUND OF THE INVENTION

Floor panels are oftentimes used nowadays for forming floors by adjoining numerous panels. Floor panels commonly support a scoff resistant and an aesthetically pleasing appearance at the top of the panel. Oftentimes the aggregation of adjoining floor panels forms a floor surface that is not directly adhered, nailed, or otherwise attached to the underlying surface, an arrangement colloquially known as a ‘floating floor’. In recent years engineered wood and laminated synthetic floor panels gained acceptance as an inexpensive and easy to install floor covering. Floor panels are available in numerous forms.

Various methods of adjoining floating floor panels to each other are known, and include, amongst others, tongue and groove, mechanical interlocking, adhesive joints, and combinations thereof (by way of example a tongue and groove may be considered as a form of mechanical interlocking). A floor made of such panels comprises a plurality of floor panels adjoined to form the floor covering. Generally outer edges of individual floor panels have abutments which complement the respective opposing edge of operationally adjacent panels, to facilitate the joining of adjacent floor panels.

U.S. Pat. No. 7,155,871 to Stone et al. provides an example of adhesive overlap floor panels, which utilizes flat overlapping abutment type. As shown in FIGS. 1-4, Stone describes a flooring construction that utilizes a glued overlap installation of numerous flooring panels. FIG. 1 depicts a top view and FIG. 2 depicts a side view along section line Y-Y′ of a floor panel 1 which is prepared as a laminate having at least a top layer 2 and a bottom layer 4 arranged at a layer offset arrangement. The top layer 2 extends an offset amount α beyond a long edge 5 of the bottom layer 4 to form an upper side abutment 20S between the top layer long edge 7 and the bottom layer long edge 5. A short edge 10 of the top layer also extends an offset amount β beyond a short edge 15 of the bottom layer 4 to define an upper end abutment 20E between edges 10 and 15, where the upper abutments extend beyond and above the bottom layer 4. A lower side abutment 30S of the bottom layer is formed between the side edge 35 of the top layer 2 and the side edge 37 of the bottom layer 4, and a lower end abutment 30E is defined between the short edge 40 of the top layer and the short edge 45 of the bottom layer. It is noted that width α and β may or may not equal each other.

FIG. 2 depicts a simplified cross-section of panel 1 along section line Y-Y′. FIG. 3 depicts a cross-section along section line X-X′, of two floor panels like the type depicted in FIG. 1, enumerated 1A and 1B respectively, joined together. Numeral 10J indicates the join of the edge 10 of panel 1A with the edge 40 of panel 1B, while numeral 15J indicates the join of the short edge 15 of panel 1A with the short edge 45 of panel 1B. The opposing upper end abutment 20E of panel 1A and lower end abutment 30E of panel 1B are adhered to each other forming an adhesion zone 50. FIG. 4 is an enlargement of the adjoining area between panels 1A and 1B, showing the substantially complimentary upper 20E and lower 30E abutments in engagement and the adhesion zone 50 formed therebetween to firmly abut the panels A1 and A2. It is noted that similar adjoining structure may be formed between respective side abutments of adjacent floor panels (not shown).

U.S. Pat. No. 8,793,959 to Ruland provides an example of adhesive slotted overlap abutment type. A slotted overlap abutment is similar to the flat adhesive overlap joining method such as described by way of example in the Stone et al. patent, except for complementary protrusion(s) and groove(s) disposed on operationally respective matching abutments. The slotted overlap abutment may also be considered as one version of mechanical interlocking type abutment, however generally such abutment type utilizes an adhesive bond, while a ‘pure’ mechanical interlocking abutments commonly do not necessitate adhesive. FIG. 5 depicts an exemplary cross-section of substantially complementary slotted overlap abutments 20 and 30 of two floor panels 1A and 1B respectively. The abutments are shown one above each other to better demonstrate the substantially complementary nature of the abutments, where upon assembly of two adjacent floor panels the protrusion 60 would be disposed in, and engage the slot 55. Additional slot/protrusion pairs, and/or differing shapes of the slot/protrusion arrangements may be utilized.

In some embodiments the panels are supplied with adhesive pre applied on mating surfaces, as denoted for example in FIG. 5 by the adhesion zones 50A and 50B, which will form a single adhesion zone when the floor panels are joined. The numeral 50 would be utilized as a general designation of an adhesion zone, whether single or double sided, and whether the adhesion zone merely has adhesive thereon, or it is already adhered to the complementary zone which may be with or without adhesive prior to mating the complementary zones.

The Stefan-Boltzman law of radiation states that as the temperature of a heat source increases the radiant energy output increases to the fourth power, as opposed to a direct proportion of energy increase provided by conductive or convective heat sources. This makes radiant energy an efficient heating method and heat is sometimes provided by heating panels such as wall panels, ceiling panels, and floor panels which become efficient sources of radiant heat when heated. Electrical under-floor radiant heat systems call for laying a heat source under a floor which may comprise floor panels, carpets, concrete, and the like. Various methods are known for such radiant heating elements. By way of non-limiting example, U.S. Pat. No. 4,485,297 to Grise et al. provides a heater fitting for under-floor installation comprising generally elongated thin plastic substrate. Two longitudinal metallic busbars are disposed near the edges of the substrate and a plurality of crosswise resistive bars are formed therebetween and are fed energy therefrom. The resistive bars and the busbars are covered with a second plastic sheet which serves to insulate and stabilize the heating element. Such heating element is thin and may be provided as long rolls, or any other desired shape, as dictated by manufacturing considerations. Heating elements like the Grise element may be laid under a floating floor.

U.S. Pat. No. 8,835,809 to Daring et al. describes an example of a radiant heat system comprising of mechanically interlocking panels, where individual panels have a heating element disposed between its various layers. Power to the heating element is provided via the interlocking adjoining structures along the shorter edges of the panel. The '809 patent eases the installation of a radiant floor, however the connection method offered by the '809 patent may be subject to shorting or worse, electrocuting a person, under certain conditions since the connection is not inherently sealed. Other connection methods are known, including tongue and groove type solutions, specialized connectors, and the like, however the moisture sealing capability of those solutions is lacking or requires additional steps and materials.

U.S. Pat. No. 4,485,297 7,155,871, 8,793,959 and 8,835,809 are incorporated herein by reference in their entirety

There is therefore long-felt and heretofore unmet need to provide floor, wall, and/or ceiling based radiant heat system, which is safe and moisture resistant. Further description shall utilize heated floor panels by way of example.

### SUMMARY OF THE INVENTION

In order to provide a safe and easy to install radiant heat system, aspects of the present invention provide various types of heating panels which contain at least one heating element disposed in the panel and electrical connecting contacts which are disposed on opposing, complementary abutments of adjacent panels in a manner that when the panels are arranged in a pre-configured continuum, the contacts would provide electrical path for energizing the respective heating elements. An important aspect of the invention provides the heating panels with sealing zones and/or adhesion zone(s) disposed about the contacts, so as to provide environmental protection to the contacts from the like of liquids which may reach the contacts from above or under the panels without such sealing. Such liquids may cause short circuit, in certain case overheating at some areas, and potentially causing risk to humans if liquid reaches live contact and a human contacts the liquid and an opposite potential. When panels arrive at the installation site with integrated/pre-applied adhesion/sealing zones, installation is simplified and more uniform sealing quality may be obtained as compared to field application of sealant. It is noted that a sealing zone may act as an adhesive zone and vice versa, and the terms ‘adhesive zone’, ‘seal zone’, ‘sealing zone’, and ‘sealant zone’ may be used interchangeably.

In some embodiments the heating panels are of adhesive flat overlapping and/or adhesive slotted overlapping type, and when connected adhesive zones on one or both of the abutments form adhesive zones which acts as both an adhesive and a sealant to the electrical contacts, to provide protection from spills, and the like. In other embodiments the a tongue and groove type or mechanical interlocking connection method between panels may be utilized, with integral sealant arrangements disposed to provide the required environmental protection. Aspects of the invention also provide methods of placing a plurality of heated floor panels for utilizing the heating floor panels to form a radiant heat floor, and for optional connectors and methods to facilitate connecting such heating floor to electric power, as well as optional methods and devices for disconnecting heating elements in individual panels.

It is an object of an aspect of the invention to provide heating panel based flooring system with improved sealing of electrical contacts electrically coupling between adjacent panels. It is a further object of an aspect of the invention to provide a connector bar or bars for ease of supplying electrical energy to a plurality of heating panels. Further aspect of the invention provides connecting elements for interconnecting one or more connector bars, and/or for supplying power to a connector bar(s), as well as providing optional construction for connectors connecting between panels.

It is an optional object of yet another aspect of the invention to provide a heating panel having a switching device switchable between an on and an off state by the activation of magnetic field of predetermined parameters, and that have such switching device maintain the last state into which it was switched until the activation of a magnetic field which would cause the switch to assume the opposite state.

In a basic embodiment of the invention there is provided a heating panel comprising a polygonal body having at least a first and a second opposing edge regions which are generally termed ‘abutments’ herein. The heating panel has a top and bottom surfaces separated by a panel thickness. At least a pair of electrical busbars, and at least one electrical heating element are disposed between the top surface and the bottom surface of the heating panel, the heating element is directly or indirectly electrically coupled between the busbars for receiving electrical energy therefrom. A first pair of electrical contacts is disposed in or about the first abutment, and a second pair of electrical contacts is disposed in or about the second, opposing abutment, the contacts being disposed on their respective abutments in substantially complementary position, for providing electrical communication between the panels. Each contact of the first pair of contacts being electrically coupled by a respective busbar of the pair of busbars to a respective contact of the second pair contacts. Sealant and/or adhesive is disposed about at least one of the abutments so as to operationally form at least one sealant zone disposed adjacent to at least one contact of the pair of contacts of the respective abutment, in a manner that limits fluids from reaching the respective contact.

At least two contacts are disposed on their respective abutments in substantially complimentary arrangement such that when two similar panels are operationally laid end to end adjacent to each other, respective contacts on opposing abutments of the adjacent panels form a matching contact pair, one contact on each of the panels. The matching contact pair will form an electrical energy path between the two panels. Different types of contact types may be utilized for the matching pair, and the two contacts of a matching contact pair may be dissimilar. One or both of the contacts may have matching flat surfaces, one or both of the matching surfaces may be convex, one contact may be concave and the matching contact may be convex. Blade and socket type may form a contact pair, and similarly snap like contacts, mutual engagement contacts and the like may be utilized, by way of non-limiting examples. Various matching contact pairs may be constructed such that at least one contact member coupled to one panel having one side of the matching contact displaces to predetermined extent a counterpart contact member coupled to the second heating panel. To insure good contact, one or both of the matching contacts may utilize resilient force. One or more of the contacts may utilize resilient and/or elastic force to engage or apply pressure to a portion of the other contact, providing good electrical contact. In such an arrangement a portion of one contact may displaces a resilient portion of the matching contact, the resilient force may be implemented by a spring, sprig membrane, elastic member, and the like. In substantially flat contacts, including opposing convex and convex/concave type contact pairs mechanical arrangements may be utilized to urge the contacts against each other, and in adhesive type abutments the adhesive power may be utilized.

Advantageously, the sealant is distributed such that when two similar panels are coupled in contact registration, the sealant form one or more sealant zones around at least one matching contact pair in the respective pair of matching contacts formed by the two panels. More advantageously, the one or more sealant zones seal the contact(s) from fluids which may be above or below the panel, once the panels are operationally coupled. In certain embodiments all contacts all the contacts are surrounded by a single sealing zone and in others the sealing zone surround one or more individual contact pair.

In certain embodiments the heating element comprises a plurality of sub-elements, however such plurality of heater sub-elements may be considered as a single heating element.

The adhesion zone may be disposed on one or both of the abutments, and once a surface with an adhesion zone is engaged with an opposite and complementary adhesion zone, adhesion zones of opposing surfaces are considered to form a single adhesion/sealing zone. The adhesion zone may surround both contacts of the pair or each of the contacts, forming an individual seal about the matching contact pair. Advantageously, one or more adhesion zones are pre-applied to the respective abutment, such as during the panel manufacturing process by way of example. Further optionally adhesion zones on two complementary abutments may interact with each other to provide better adhesion, better sealing, or both. In certain embodiments the adhesion zone operationally provides compressive force for urging opposing contacts against each other. Optionally the adhesive/sealant may comprise of at least two different materials, where one of the materials is formed as a sealant zone on one abutment and the second of the materials is formed on an opposing abutment, the materials forming a single sealing zone when the two opposing abutments of the two heating panels are operationally attached. Further optionally different portions of the sealing zone may be disposed on opposing abutments. By way of example assuming an embodiment which calls for an annular sealing zone around a matching contact pair, such may be formed as half a circle of the sealing material being disposed on one abutment and a complementary half circle disposed on the opposing abutment such that the two half circles complement each other to form a ring around the contact pair when opposing panels are operationally laid adjacent to each other. Alternatively the annular sealing zone may be formed on a single abutment around one of the contacts in the contact pair and the sealing zone may be completed by contacting the opposing abutment of the second panel in the pair. In yet another embodiment, complete circles of sealing elements may be formed on both opposing abutments in a complementary positioning, the circles may be of similar or dissimilar materials. Dissimilar materials may also form epoxy type sealant by the contact between the opposing abutments. The circle example provided above should not be considered limiting as any desired shape sealing zone may be utilized. As stated above the sealing zone may also act as an adhesive zone, and an adhesive zone of an adhesive abutment type may be utilized as a sealing zone.

In some embodiments, the heating panel has an adhesive overlap or a slotted adhesive overlap abutments, each of the abutments having an abutment thickness smaller than the panel thickness. Optionally, the adhesion zone acts as a combined adhesion and sealing zone, or both an adhesion zone and a sealing zone may be present.

In some embodiments the body of the heating panel comprises a plurality of overlaid layers. Optionally the layers are laid with an offset overlap to form the abutments on non-overlapping portions of the plurality of layers. Further optionally the layer comprise sheets of insulated material, such as plastic sheets by way of example. In other embodiments the panel is cast over pre-prepared electrical components. Other manufacturing methods may be utilized to meet functional, cost, regulatory and or other requirements. Optionally the sum of the thickness of opposing abutments equals the thickness of the panel body. In some embodiments at least two of the plurality of overlaid layers are made of differing materials and/or thicknesses. Optionally mechanical protection layers may be utilized above and/or below energized components such as the busbars, contacts, and the heater element. The mechanical protection may be of different material than the material surrounding it.

In some embodiments, tongue and groove abutment type is utilized. In such embodiments one of the heating panel abutments comprises a groove, and the opposing abutment comprises a substantially matching tongue, and one or more sealing zones are disposed about contacts in one or both abutments, such that when two heating panels are operationally coupled the sealing zone seals at least one pair of matching contacts of the pair of contacts in the respective abutment. Optionally the pair of matching contacts is disposed within the tongue and groove region. In certain embodiments the abutments comprise sealing pockets into which sealant may be disposed. It is noted that the term tongue and groove and its related variations extend to cover all types of interlocking abutments, including where a single abutment may comprise both a tongue and a groove, such as that schematically shown in FIG. 33 by way of example.

In embodiment utilizing adhesive overlap, whether or not slotted, the contacts will generally face each other or, stated differently, one matching contact will operationally face upwards and the matching contact faces downwards. However other arrangements may be utilized as allowed by the abutment type of the heating panel. By way of example in a tongue and groove type abutments one contact may wrap around the other, contacts may be horizontally or vertically opposed, angled, and the like.

Optionally, the heating panel further comprises a ground plane disposed at least between the heating element or a portion thereof and the top surface, and at least a first ground electrical contact disposed on or about the first abutments and a second ground contact disposed on or about the second abutment in substantially complimentary position, the first and second ground contacts being electrically coupled to the ground plane. The ground contact(s) are disposed on the respective abutment or on an abutment wall at an edge of the abutment, so as to operationally provide electrical continuity between ground planes of adjacent heating panels when the panels are mutually coupled. Alternatively the first and second ground contacts may be disposed on other opposing, edges of the heating panel from the abutments having the operationally energized contacts. It is noted that the ground plane, whether a grid, solid, braided shield, printed conductive grid, and the like, may act as its own busbar. The grounding contact may or may not be sealed by a sealant zone. The ground plane is electrically insulated from the busbars and the heating element.

Optionally the ground plane comprises a ground grid with sufficient density as to form electrical path between the ground plane and an operationally energized component such as a busbar and/or a portion of the heating elements, if a conductive item pierces the panel to a level that would reach the energized components. Such arrangement would allow disconnection of electrical energy to the panel by tripping of a ground fault interrupter.

In certain embodiments the panel further comprising a severable link electrically connected in electrical series connection with the heating element. Such link allows disconnection of the heating element from the power if, by way of example, the integrity of an individual panel is compromised or if it is desired for any reason that the panel would not provide heat, without effecting other panels which are fed by the disconnected panel busbars. Optionally the severable link is a fuse. In some embodiments the severable link is manually disconnectable, such as by drilling a hole through at least a portion of the panel at predetermined location. A plug may be utilized to insulate and seal the drilled location, or the hole may be drilled to predetermined depth from bellow the panel. Commonly it is desirable that disconnecting the severable link would disconnect only the heating element in the panel while the busbar continue to provide energy to downstream panels.

Optionally a magnetically operated switch is disposed within the body, the switch being connected in series with the at least one heating element.

There is also disclosed a switching element which is magnetically operated. The switching element may comprise a magnetically contactor element disposed to selectively transition the switching device between an on state and an off state respectively responsive to exposure to predetermined magnetic field, in a manner that will leave the switching device in the state to which it was transitioned until an opposite magnetic force is applied to transition the switching device into an opposed state. In some embodiments the switching element is rotatable responsive to the magnetic field, and the rotation transitions the switching device between states. In other embodiments the switching element comprises a concave ferromagnetic member and reversing the concavity transitions the device between the on and off states.

In embodiments utilizing a severable link or a switch and sub-elements, optionally sub-elements or groups of sub elements are separately disconnectable.

Yet another aspect of the invention comprises a connection bar for connecting a plurality of heating panels, each of the heating panels having an abutment having a plurality of electrical contacts disposed thereupon or therein, the connection bar comprising an elongated abutment section having a plurality of conductors, each conductor electrically coupling in parallel a plurality of contact areas or forming such contact areas, the contact areas are disposed to comport with the electrical contacts on the panel abutment and form a corresponding registration therebetween, and an adhesion and/or sealing zone operationally disposed about at least one contact area. Optionally, the adhesion zone comprises a plurality of adhesion sub-zones, each disposed to seal at least one direction of at least one respective contact area. Optionally the conductors comprise a plurality of busbars extending longitudinally in or upon the connector bar elongated abutment, the busbars are disposed at a distance such that being coupled to a heating panel upper abutment, at least two busbars are disposed substantially complimentary to the contacts on the upper abutments of corresponding heating panels or are spaced so as to act as contacts cooperating with respective contacts on the upper abutments of the heating panels, the abutment section and/or the upper abutments having an adhesion zone disposed to seal at least one busbar. Optionally, the adhesion zone comprises a plurality of adhesion sub-zones, each disposed to seal at least one direction of a respective busbar.

Optionally the connector bar is of the adhesive overlap or the adhesive slotted overlap abutment type, dimensioned to fit a corresponding abutment of a matching heating panel, and operationally couple electrical energy thereto. Alternatively the connector bar abutment may be of tongue and groove construction corresponding to an abutment of a matching tongue and groove type heating panel. Further optionally the connector bar abutment may be of a mechanical interlocking construction, corresponding to an abutment of a matching mechanical interlocking type abutment.

Optionally the connector bar further comprises a resilient spacer disposed on a side of the connector bar opposite the abutment. Optionally the spacer bar is formed as a honeycomb.

Yet another aspect of the invention relates to adaptors for the connector bar. There is further provided an optional connector bar adapter for electrically coupling a first and a second connector bars each having an edge having a plurality of contacts, the adapter having an adapter body having a first edge having a plurality of contacts corresponding to the plurality of contacts at the edge of the connector bar.

In some embodiments the adapter body having a second edge having a plurality of contacts disposed to correspond with a plurality of contacts at an edge of a second connection bar, each of the plurality of contacts on the first edge being electrically coupled to a corresponding contact on the second edge.

In some embodiments the adapter body is angled.

In some embodiments the adapter further comprises a plurality of terminals or wires, each of plurality of the terminal or wires being electrically coupled to a corresponding contact of the plurality of contacts on the first edge.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples. The drawings are provided to facilitate understanding of various aspects and options of the invention, and no attempt is made to make the drawing conform to scale, nor to maintain a uniform scale between various drawings. Furthermore many of the drawing elements are shown without depth considerations and/or that certain objects are potentially being hidden as the drawings are provided only to facilitate understanding of various aspects of the invention. For clarity certain views are provided ‘flattened’ so as to show elements that would have been hidden by constructs closer to the viewer, however in certain cases the disclosure specifically denotes depth relationship, such as element A covering element B, and such specifically disclosed spatial relationships should be considered in accordance with the relevant text.

For brevity of the description, unless deemed needed for clarity, when denoting a plurality of similar items these specification shall utilize generally similar numerals, and specific letters shall be annexed to the numerals to denote specific instances of the item when deemed required for extra clarity. Thus by way of example, the numerals 20 and 30 shall relate to an upper and lower abutments respectively, regardless of the edge of the floor panel along which they are formed, yet as seen in some figures the numerals may be utilized as 30E and 30S to denote side and end lower abutments respectively and 20E and 20S are utilized to enumerate the respective upper end and side abutments; In other drawings the numeral 20 denotes an upper abutment and 30 denotes lower abutment, without specifically denoting the abutment edge, or relating to both edges. Furthermore, several enumerated elements depict a plurality of generally similar elements and such depiction should be considered to represent any number of such elements unless otherwise described. Furthermore, throughout this disclosure, subscripted reference numbers (e.g., 10₁ or 10_{A}) or primed reference numbers (e.g. 10′ or 10″, etc.) may be used to designate multiple separate appearances of elements of a single species, when in a drawing or not; for example: 101 or 10′ is a single appearance (out of a plurality of appearances) of element 10. The same elements can alternatively be referred to without subscript (e.g., 10 and not 101) when not referring to a specific one of the multiple separate appearances, i.e., to the species in general.

FIG. 1 depicts schematically a top view of a floor panel having upper and lower adhesive abutments.

FIG. 2 depicts schematically a side view of the floor panel of FIG. 1.

FIG. 3 depicts schematically a cross-section of two floor panels in connection relationship.

FIG. 4 depicts schematically a magnified view of a joint between two adjacent floor panels.

FIG. 5 depicts schematically magnified view of a joint between panels utilizing adhesive-slotted overlap abutment.

FIG. 6 depicts schematically a simplified top view of a heating panel.

FIG. 7 depicts schematically an enlarged view of complimentary abutments of two adjoining heating panels in an offset condition and FIG. 8 depicts the same being adjoined.

FIG. 9 depicts schematically an enlarged view of complimentary abutments of two adjoining heating panels showing schematically optional ground contacts and ground plane.

FIG. 10 depicts schematically an enlarged view of complimentary abutments of two adjoining heating panels showing staggered contact example.

FIG. 11 depicts schematically an enlarged view of complimentary abutments of two adjoining heating panels showing an exemplary adhesive slotted abutment design, and FIG. 12 is a simplified cross-section view of adjoined abutments of FIG. 11.

FIG. 13 Depicts schematically a simplified cross-section of an exemplary side view of an embodiment of the heating panel.

FIG. 14 depicts schematically a top view of an embodiment showing optional structure of the heating element.

FIG. 14A depicts schematically a top view of an embodiment showing optional structure of the heating element, and a severable link.

FIGS. 14B and 14C depict schematically one embodiment of switching device disposed in the panel while FIGS. 14D and 14E depict another embodiment of the same.

FIG. 15 depicts schematically a simplified top view of an embodiment of a connector bar.

FIG. 16 depicts schematically a simplified side cross-section of the connector bar engaging a heating panel.

FIG. 17 depicts schematically a simplified top view of panels being attached to the connector bar.

FIG. 18 is schematically a simplified cross-section of an exemplary sealing bar.

FIG. 19 depicts schematically two connector bars coupled together, and showing several optional features.

FIG. 20 depicts schematically a simplified cross-section of an extension adapter.

FIG. 21 depicts schematically a double-sided connector bar adapter.

FIG. 22 depicts schematically an angled adapter.

FIG. 23 depicts schematically an optional construction of a connector bar, showing an optional spacer.

FIG. 24 depicts schematically a bottom view of an end section of a heating panel designed to couple to the connector bar of FIG. 23.

FIG. 25 depicts schematically a flattened cross-section side view of a portion of a heating panel being coupled to the connection bar of FIG. 23.

FIG. 26 depicts schematically side-by-side sections of an upper and lower layers of an exemplary connector bar for three-phase powered floor.

FIG. 27 depicts schematically a top view of the section of the connector bar of FIG. 26.

FIG. 28 depicts schematically a simplified schematic diagram of a laid floor section showing interconnected heating panels and connector bar.

FIG. 29 depicts schematically a long side view of an embodiment of a heating panel utilizing tongue and groove arrangement, and FIG. 30 depicts schematically a short side view of the same.

FIG. 31 depicts schematically an optional embodiment of coupled matching contacts while FIG. 31A depicts schematically the same in disengaged, but aligned to engage disposition.

FIG. 32 depicts schematically another optional embodiment of coupled matching contacts while FIG. 32A depicts schematically the same in disengaged, but aligned to engage disposition.

FIG. 33 depicts schematically a cross-section of exemplary mechanical interlock type abutment, showing optional contact location and optional sealant zones.

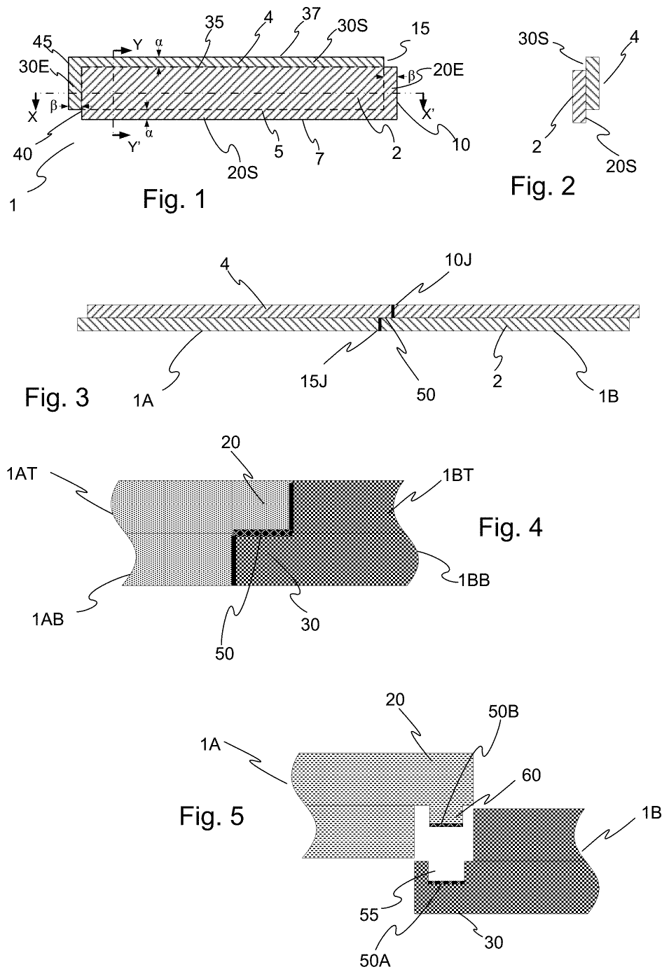

### DESCRIPTION OF EXEMPLARY EMBODIMENTS

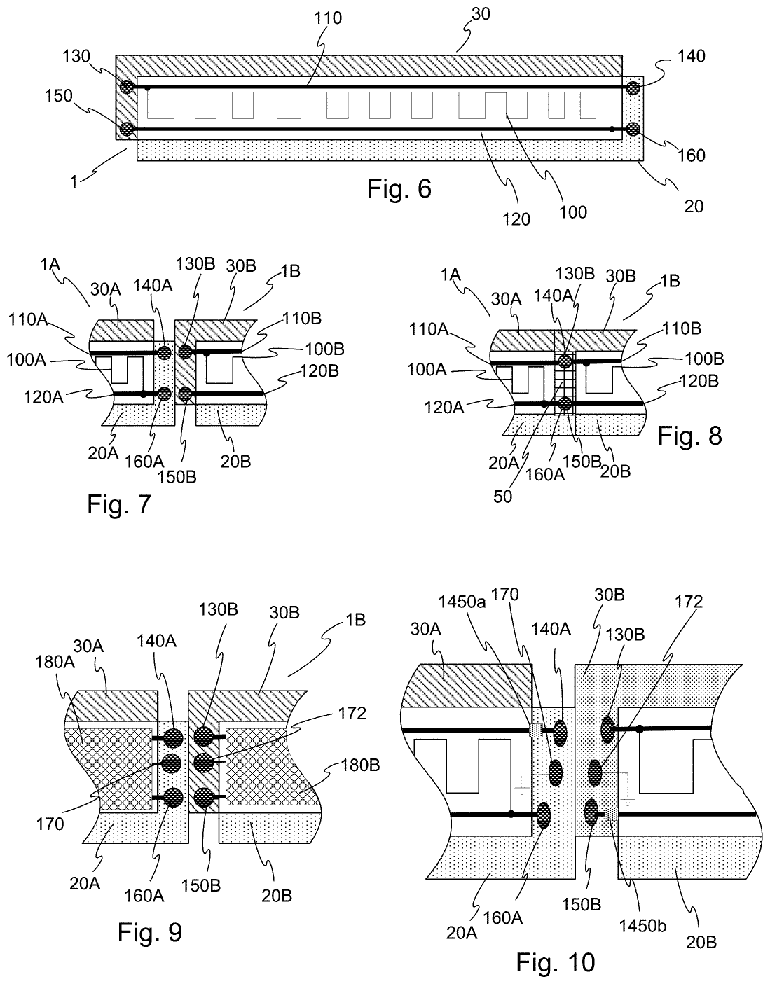

FIG. 6 depicts a simplified schematic view of an adhesive abutment type heating floor panel in accordance with an aspect of the invention. FIG. 6 depicts the heating panel 1 with a heating element 100 disposed between the upper and lower surfaces of the panel. The heating element is electrically coupled to two busbars 110, 120. The busbars are electrically coupled with respective contacts disposed in the abutments, for transmitting electrical power; busbar 110 is connected to contact 130 on the lower abutment 30, and to contact 140 on the upper abutment on the opposite end of the panel, and busbar 120 is electrically coupled to contact 150 on the lower abutment 30 and to contact 160 on the upper abutment 20.

The busbars may be made by any method and using any materials which would provide sufficiently low resistivity to carry the maximum current allowed for a row of consecutively connected panels, in accordance with a desired design criterion, while causing less voltage drop than the design criteria allows. Busbars may be formed of any conductor, but are depicted in numerous drawings as elongated flat metal bars. By way of example, commonly the allowed power density of under-floor heating is 15 W per square feet. Assuming a surface area of 1.5 square per panel, and an applied voltage of 220V, a single panel consumes about 0.1 A, and if ten consecutive panels are allowed to be connected, the busbar should be able to sustain a current of at least 1 A without causing excessive voltage drop and/or heat above the allowed heat density. Clearly safety margins are desired. Busbars may be made, by way of example, from metal strips, electrical wires, conductive compounds such as low resistivity graphite, metal pastes, conductive polymers, conductive fibers such as carbon fibers, graphene, and the like. In some embodiments the busbars extend along opposing abutments such as, by way of example if the contacts are disposed at the abutments along opposing short ends, the busbars may extend along the abutments of the long ends.

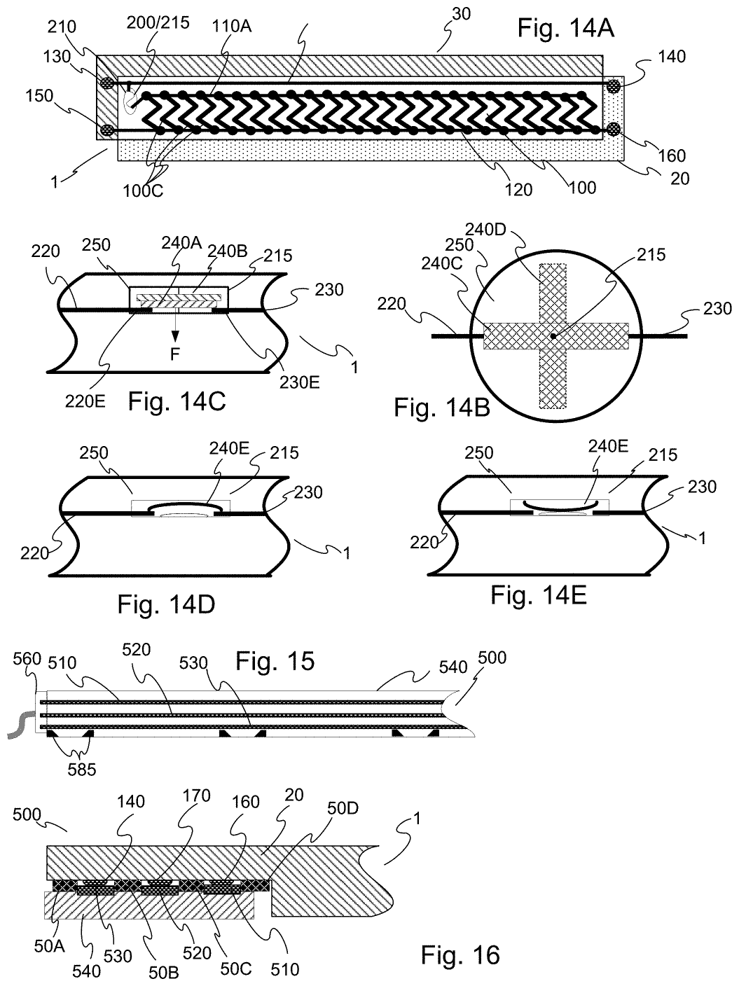

The heating element may also be formed in numerous ways that will be clear to the skilled in the art. By way of example the heating element may be formed as shown schematically in FIG. 6 by a single long resistive element, by a volume of semiconductive material, by a plurality of resistive elements extending between the busbars known as chevrons, as shown by way of example in FIG. 14, by thin sheet resistive elements such as foil, graphene or metal alloys, by positive temperature coefficient (PTC) materials, and the like.

Certain heating system configurations may call for three phase power, and in optional embodiments the heating panel 1 may contain additional busbars. Optionally, in such systems the heating panel comprises a plurality of heating elements each connected between differing busbars. In certain embodiments alternating heating panels feeding each other would utilize power from different phases.

The contacts 130, 140, 150 and 160 are disposed such that when two panels are operationally laid end to end with corresponding abutments of the two panels being brought in contact and coupled to each other, contacts on the respective upper and lower abutments, or opposing abutments in embodiments utilizing tongue and groove, are in alignment sufficiently to create good electrical contacts between the respective busbars of the panels. Various types of contacts such as flat, opposing concave, concave/convex, blade, button, and the like may be utilized.

FIG. 7 and FIG. 8 depicts simplified top view diagram of an enlarged end areas of two exemplary panels 1A and 1B respectively. In FIG. 7 the panels 1A and 1B are shown in offset longitudinal alignment prior to being joined, while FIG. 8 shows the panels joined. The component enumeration was modified by adding to visible items of FIG. 6 a suffix indicating the respective panel letter, namely A or B respectively. It is seen that if panels are joined so that the end portion of panel 1A upper abutment 20A overlaps the end portion of panel 1B lower abutment 30B, the contacts 130B and 140A are brought into electrical communication forming one matching contact pair, and contacts 150B and 160A are brought into electrical communications, forming a second matching contact pair. Operationally adhesion zone 50 at least partially surrounds the contacts, and the adhesive bond between the top and bottom abutments urges respective contacts towards each other to provide good electrical contact, as well as acting as an environmental seal to block liquids from reaching the contacts. As busbars 110 and 120 have negligible resistance, a low resistance electrical path is formed for connecting energy between consecutively coupled panel.

As described above, a disadvantage of prior art heating panels relates to sealing of the contacts from moisture and other contaminants. An advantage of utilizing heating panels of the adhesive overlap and/or of the adhesive slotted overlap type stems from using adhesive type abutments where the adhesive forms an adhesion zone 50 about the contacts which acts as a sealant zone to protect the contacts from environmental hazards such as liquid spills and the like. In some embodiments the adhesion zone 50 is only partially disposed about the contacts, protecting the contacts from only one direction such as preventing liquid on the top of the floor panel from reaching the contacts. Adhesive may be applied to the adhesion zone of one or both of the opposing abutments. In most implementations the contacts are not covered by the adhesive as doing so may impair electrical conductivity between the cooperating contacts, however in certain implementations conductive adhesive may be pre-applied to the contacts to ensure good, long-lasting contact. In such implementations a non-conductive sealant and/or adhesive is used between contacts. Optionally grease or other protective compound may be pre-applied to the contacts before adjoining heating panels.

In heating panel embodiments which utilize tongue and groove or mechanical interlocking abutments the sealing/adhesive zone 50 offers similar advantage but the mechanical nature of such abutments allow for smaller sealing zones, and for sealing without adhesion.

It is desired but not mandatory that the top surface of the top abutment of operationally cooperating abutments would be substantially at the same level as the top surface of the body of the panel, so as to form an even floor. An optional way to achieve this goal is to form the cooperating abutments such that the sum of the thickness of the cooperating abutments would substantially equal the thickness of the body of the panel. If optional additional layers such as a bottom foam layer are utilized in the panel, than the flat floor may be achieved by having the combined thicknesses of the cooperating abutments and all the optional additional layer(s) would equal the thickness of the body and the additional layers. Thus additional layers such as mechanical protection, texture layers, noise reduction layers, and the like may be added.

Yet another safety concern in electrical radiant heat systems is the risk of piercing the protective upper layer. Oftentimes regulatory requirements demand that electrically energized elements of the heating system be protected either by a sufficiently strong mechanical protection or by a ground protection. Ground protection should be designed to provide an electrical path of sufficient conductivity between energized components and the electrical ground to trigger a ground fault interrupter (GFI) if operationally the body of the heating panel is compromised to present electrocution or fire hazard, Such ground may be provided by using a screen disposed concentrically about each energized wire, or by a ground sheet or grid disposed above the powered elements. Optionally heating panels disclosed herein may comprise of such a feature, as shown schematically in FIG. 9. As seen, a ground contact 170 is disposed on the upper abutment of one panel and an opposing ground contact 172 is disposed on the operationally cooperating lower abutment and each is electrically coupled to a ground plane 180A and 180B for each panel respectively. The ground plane is either continuous or grid like, and is disposed at least partially above the heating element, the busbars and/or any other powered component. The ground plane does not require a separate busbar as it acts as its own conductor, however a separate ground busbar may be provided. Further, in certain embodiments the ground contact may be coupled to other grounding structure, such as, by way of example, the shield of a shielded conductor and the like. The ground plane 180 may constitute solid metal covering, metal grid, printed or deposited conductive material in sheet or grid form, conductive fibers such as carbon fibers, conductive polymers, woven or non-woven conductive fabric, and any other shield in the form of a grid or of traces covering energized components. While the ground plane may present some resistance, it is desired that such resistance be minimized, and in any case such resistance would be sufficiently low to assure triggering a disconnect by a GFI.

Optionally, the location of the contacts on the abutment may be staggered as seen for example in FIG. 10, however non-staggered placement is easily obtained for example by using a technique similar to the one depicted in FIGS. 23-27.

FIG. 10 further depicts an optional feature which may be utilized in any embodiment of the heating panel, and in certain embodiments of various connector bars and/or couplers. In order to improve sealing of the busbars from environmental effects an insulation mask 1450a and 1450b may be utilized. Such insulation mask is an insulating and/sealing layer disposed at least at the area where the lower abutment of a first heating panel mates with the upper abutment of a consecutive panel. The mating of the two consecutive panels may leave a small gap between the upper surfaces of the respective panels, sufficient to allow liquids to penetrate and contact the busbars, causing a risk of shorts, and potentially even electrocution of persons. In order to protect against such occurrence, at least the area of the busbar under the upper mating region of the two panels is sealed by an insulation mask 1450a, 1450b. Stated differently, when a pair of consecutive panel are operationally coupled, the region of contact of the respective upper surfaces of the respective panels define an inter-panel mating region, and busbar regions underlying the inter-panel mating zone are advantageously sealed by insulation masks. The insulation masks 1450a and 1450b are formed by applying a sealant over the respective busbars at least in the inter-panel mating region. The insulation mask may be a part of the adhesion/sealing zone. The insulation masks may be formed of sealant directly applied over the busbars, by application of sealing tape over the respective busbar, by utilizing insulated and sealed busbar, or by any other convenient method. Notably, insulation masks may advantageously be disposed on both busbars under the inter-panel mating zone, and in some embodiments over the region where the lower abutment meets the adjacent panel, to protect against fluids coming from below the panel.

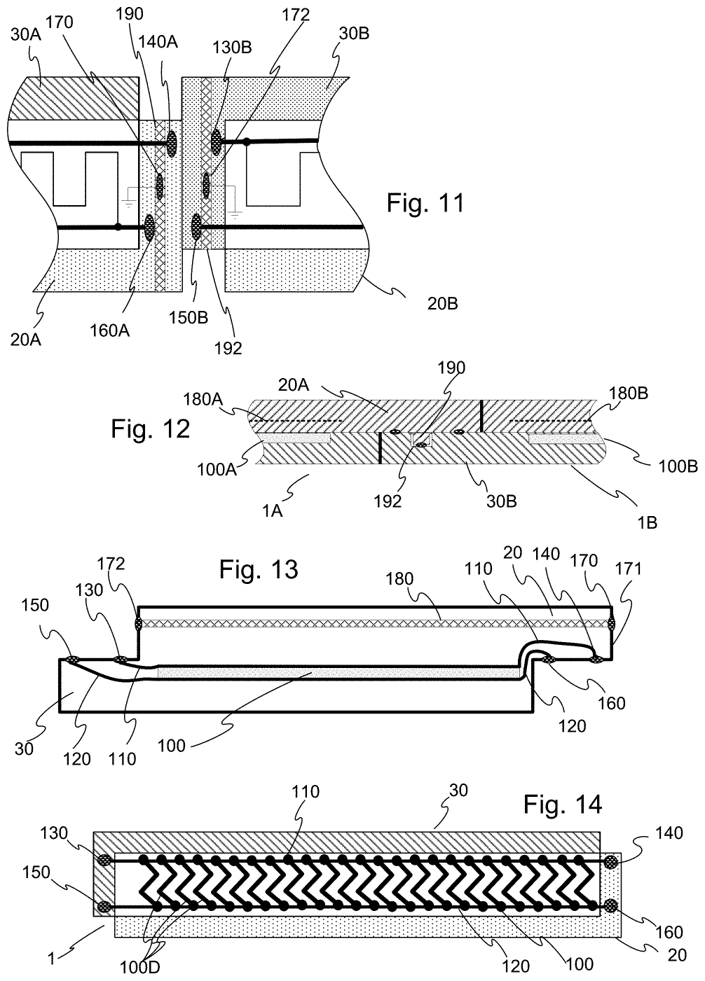

As described above optional embodiments of the invention utilize slotted adhesive slotted overlap abutments. An example of such embodiment is provided in schematically in FIGS. 11 and 12. FIG. 11 depicts a protrusion 190 on upper abutment 20A, and a complementary slot 192 on lower abutment 30B. The depicted placement of the contacts is optional, and any contact placement that would prevent shorts and provide the required connectivity is acceptable, providing that at least energized contacts would be disposed between the abutments and in a manner that will provide the required electrical circuit. FIG. 12 depicts a side cross-section of the abutment region of jointed panels showing the abutments and the substantially complementary slot/protrusion pair. Notably the slot and protrusion location may be reversed, with the slot on the upper abutment and the protrusion on the lower abutment. Additional slot/protrusion pairs may be provided as desired.

FIG. 13 depicts a simplified projection of a side cross-section of one arrangement of a heating panel. It is noted that while several layers may be utilized in the construction of a heating panel under some embodiments, other embodiments may utilize casting of the various components in one or more casts of matter such as polymers. FIG. 13 depicts an optional method of providing a ground plane 180 extending above the energized components, terminating in contacts 170 and 172 which in the embodiment depicted in FIG. 13 terminate on the abutment wall 171, rather than the abutment itself. While the ground contacts may be sealed, it is noted that by its nature a ground plane and/or conductor presents far smaller risk and thus may be in less protected locations such as the abutment wall. However, if the abutment walls are provided with a sealant such as the adhesive or other sealing arrangement, the line contacts 130, 140, 150 and 160 may also be placed in the abutment wall. Notably, busbars 110, 120 may reside on the same plane or be staggered vertically.

FIG. 14 depicts a simplified top view of an embodiment of the heating panel 1 utilizing an alternative type of heating element. The heating element comprises a plurality of resistive bars 100D electrically coupled between busbars 110 and 120. Such resistive bars are colloquially known as chevrons (see for example U.S. Pat. No. 4,485,297 to Grise et al),. Chevrons based heating element allow cutting the panel at a point other than its end and still using the remaining portion to deliver heat. It is noted that while only a few of the chevrons are enumerated as 100D, the enumeration is directed to all the resistive elements in the heating element 100 which are electrically coupled between the busbar 120 and the busbar 110. Chevrons may be formed of any desired regular or irregular geometrical shape, and are not limited to the pattern shown and/or implied by the name.

As described above, numerous heating element designs are known, such as wire based heating elements, semiconductor or resistive volume-based heating elements, chevron based heating elements, PTC based heating elements, grid connected resistive elements, inductive heat elements, or any other technology which converts electrical energy into heat energy. The selection of the heating element type is made in accordance with considerations such as cost, heat distribution, material availability, and the like, and heating panels utilizing any heating elements of appropriate power are explicitly considered. More specifically, heating panels may utilize pre-made heating elements that are adapted for incorporation within the heating panel, or purpose made heating elements that are manufactured specifically for the heating panel use, oftentimes during the manufacturing process of the heating panel. Thus, by way of example, a heating element pre-manufactured in accordance with the Grise patent may be laminated between two insulating sheets, or resistance chevrons may be printed on one insulating sheet, busbars either added or printed as well, and an optional second sheet may be laminated on top of the chevrons and busbars. It is again noted that despite the name the resistance chevrons may be of any desired shape including straight lines, curves, and the like. It is also noted that single or a plurality of resistance elements of any kind and with any electrical arrangement which meet the desired power requirements may be utilized as heating element.

FIG. 14A also depicts yet another optional innovative aspect of the invention, an aspect which may be advantageously used with any panel-based heating system. It often happens that a specific panel should not be used for heating. By way of example the panel may be defective and thus causes tripping of a GFA protecting the heating system as a whole. Yet another example may occur when due to floor geometry or due to devices laid on the floor, the heating capacity of a specific panel should be disabled to avoid fire hazard and/or damaging the overlaid device. The ability to disconnect individual panels during floor assembly may be utilized by various combinations of contacts allowing current distribution through the busbars and selective disablement of the panel. Furthermore, it is advantageous to protect individual panels from overcurrent, and/or overheat. Thus there are provided disablement of the heating element of individual panel. Optional proposed solutions provide the capacity to disconnect a specific panel at any time even after the floor is fully assembled.

In order to provide the capacity to disconnect the heat for individual panels a severable link 200 and/or a switching device 215 is provided. The severable link is electrically connected in series between a busbar and the heating element, and its physical location is provided for the installer and/or user. When a panel disconnect is desired the severable link 200 location is drilled. Pierced, or otherwise removed at least to the depth required to severe the link 200 and thus disconnect the electrical circuit between the busbars and the heating element. Drilling may occur from the top or bottom side of the panel. A plug 210 may then be overlaid on the removed or pierced section. The plug preferably provides sufficient sealing capacity of the cut area as to protect the exposed pieces of the severed link 200.

In FIG. 14A the chevrons 110C are electrically connected between busbar 120 and an auxiliary busbar 110A which is in turn electrically coupled to busbar 110 via the severable link 200, and this arrangement allow severable link 200 to disable the heating element 100. It is noted that while only a few of the chevrons are enumerated as 100C, the enumeration is directed to all the resistive elements in the heating element 100 which are electrically coupled between the busbar 120 and the auxiliary busbar 110A. Notably, busbar 110 and auxiliary busbar 110A may be placed at different level in the heating panel depth.

Optionally, the severable link is embodied by a fuse, as depicted in FIG. 14A.

In certain implementations it is desirable to selectively disconnect and reconnect a single panel heating element. For that purpose the severable link 200 may be replaced or augmented by a switching device 215 embedded within the heating panel and effective to controllably connect or disconnect the heating element 100 between the busbars. FIGS. 14B and 14C depict one embodiment of a switching device which may be integrated in a heating panel 1 at a known location accessible from the top of the panel. The switching device 215 controllably switches between an on and off states, and thus connects and disconnects electrical communication between two wires 220 and 230. The wires 220 and 230 are connected in series with a conductor providing power to the heating element 100. The wire ends 220E and 230E act as switch contacts, or are connected to dedicated switch contacts. A switching element which in the depicted embodiment comprises a contact having an member with an elongated cross-section, commonly referred to as a blade 240A coupled to a magnetic or ferromagnetic actuator bar 240B is rotatable within a cavity 250 formed in the heating panel. FIG. 14B depicts a top view of the switching element showing the switching element in two alternative states, namely the closed state where the switching element is disposed as shown in 240C in which the contact blade 240A electrically couples between wires 220 and 230, and a second, open state, where the switching element is shown away from the 240C disposition sufficiently to prevent electrical communications between the wires 220 and 230, such as depicted by way of example in 240D. A downward force F urges the switching element or at least the contact blade downwardly against contacts that are electrically coupled to the wires 220, 230, or against the wires themselves. Such downward force prevents arcing and may be provided by numerous manners such as springs and/or levers, magnetic force, and the like. Preferably the switching element is rotatable about a shaft 260. The contact blade 240A and the actuator bar 240B may be integral and made of a single item.

In order to connect or disconnect the switching device 215 a magnetic field is applied at a known location and orientation on top of the heating panel, to interact with the actuator bar 240B so as to selectively cause the bar to rotate from the open state to a closed state, and vice versa. The magnetic force imparted on the actuator bar 240B is sufficient to overcome the downward force F, which is restored when the applied magnetic field is removed. Such magnetic field may be applied by a magnet and/or an electromagnet. The actuator bar 240B may be a magnet itself, or made of ferromagnetic material, however it is desirable that the magnetic forces involved are selected to avoid accidental connection and/or disconnection. By way of example, setting the actuator bar orientation, and thereby the switch state as on or off, may be done by placing a strong magnet or an electromagnet above the switching device location and then rotating the magnet or electromagnet to cause the rotation of the actuator bar 240B.

Yet another embodiment of a switching device is depicted schematically in FIGS. 14D and 14E. The switching device is disposed within the heating panel and comprises similar cavity and contacts coupled to the wires 220, 230 or utilizes the wire ends as contacts, as shown in FIG. 14B. The switching element comprises a stressed ferromagnetic concave switching member 240E. The orientation of the switching member 240E may be modified by properly oriented magnetic field of sufficient strength to reverse the concavity direction. FIG. 14D depicts the switch in a connected state, where the switching member 240E is oriented to provide connection between the wires 220 and 230, while FIG. 14E depicts the switching member 240E in reversed concavity, where electrical communications between the wires 220 and 230 is disconnected, and the switching device is in the off state.

It is noted that incorporation of such switching device 215 allowing such controlled activation of a heating panel is beneficial to any type heating panel and to numerous other arrays of electrical devices that do not offer convenient switching ability, however such switch is optional.

If electrical connection is not desired for a specific panel or a row of panels, insulation may be placed between the contacts of the panel and adjacent, powered panel or connector bar. Pre-cut insulator may be utilized for such purpose.

Optional aspects, devices and methods to facilitate connecting the heating panels to power are also disclosed. To that end, there is provided a connector bar, and one exemplary embodiment thereof is depicted in simplified fashion in FIGS. 15 and 16. FIG. 16 also depicts a cross-section of an abutment region of a heating panel 1. FIGS. 23-27 depict other embodiments of a connector bar.

FIG. 15 is a top view and FIG. 16 is a flattened cross-section side view of an embodiment of a connector bar. The connector bar, generally denoted by numeral 500, is an elongated structure which allows coupling of a plurality of heating panels thereto while providing power and optionally ground, for the panels. Each of the panels connected to the connector bar may in turn couple and feed power to other panels connected thereto, thus forming a complete floor row. The connector bar depicted in the drawings utilize three connector busbars, two of which are utilized to supply power while the third is utilized as ground busbar. The order of the wires may be modified as long as the connection compliments the connected panels. Furthermore, other electrical connection modes may dictate different arrangements. By way of example three phase power supply systems may utilize three energized busbars as well as optionally a neutral busbar and/or a ground busbar, and a heating system which does not utilize grounding would not require the ground busbar. Optionally, thermal sensors may be installed in one or more elements, and communication with such sensor may optionally be accomplished via a contact on the connector bar.

The connector bar comprises an elongated connector abutment section 540 having a plurality of busbars 510, 520, 530 extending along the connector abutment. In the depicted example two of the busbars are utilized for power distribution and a third is utilized for providing ground connection, and as stated above the ground busbar may be omitted in systems that do not use such ground, and additional busbars may be utilized as needed for the power supply system utilized. In the depicted example the connection busbars are exposed on the abutment section 540, and contact areas are formed at any area where a panel contact is overlaid over the respective busbar. In other embodiments the busbars may be hidden within the connector bar body and only contact areas are exposed, as seen by way of example in FIG. 23. The abutment section 540 is dimensioned to interact with a panel abutment 20, and the connector bar busbars 530, 520, and 510 are disposed to interact with panel contacts 140, 170, and 160 respectively when a panel 1 is operationally connected to the connector bar 500. In some embodiments the abutment section or a portion thereof comprises a conductor and thus the abutment itself is utilized as a busbar, commonly a grounding busbar. Commonly but not necessarily the abutment section is non-conducting. Affixing the heating panel to the connector bar may be achieved by having portions of the connector abutment, portions of the panel abutment, or both, coated by adhesive, forming yet another adhesion zone 50. Numerous adhesion zones may be utilized between the connector bar and the panel abutment. By way of non-limiting example, FIG. 16 depicts an optional arrangement utilizing four adhesion zones 50A, 50B, 50C, and 50D. Operationally the adhesion zones provide sealing of the power carrying connections between contacts 140, 160, and 170 and busbars 530, 510, and 520 respectively, from the environment, providing protection form risks such as liquid spill, corrosion, and the like. Furthermore, the adhesion zone(s) may provide a compressive force urging contacts and respective busbars against each other. Such compressive force would be applied via the connector bar abutment 540 and the cooperating panel upper abutment 20 being held against each other by the gluing of the adhesion zone(s). Similar adhesion arrangements may be utilized in matching abutments between panels. It is also noted that for practical purposes, separate adhesion zones 50A through 50D may be considered a single adhesion zone 50.

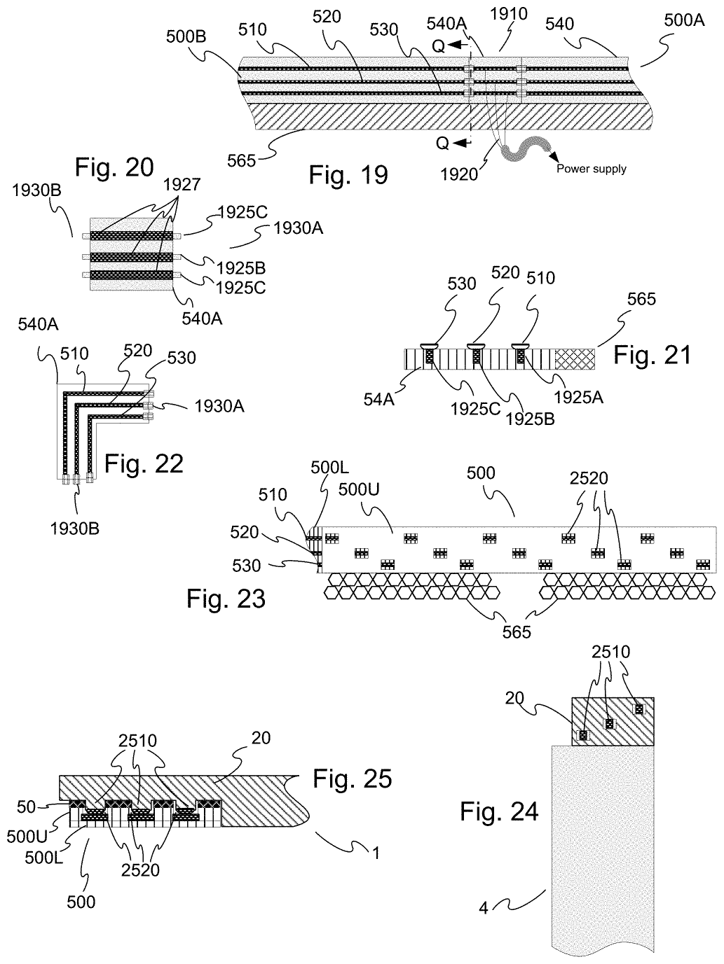

Power may be supplied to the connector busbars via an end connector 560, a center connection as shown by way of example in FIG. 19, or a top connection (not shown). It is noted that for clarity, in FIG. 16 no wiring is depicted between the contacts such as 140, 160, 170 and relevant panel components.

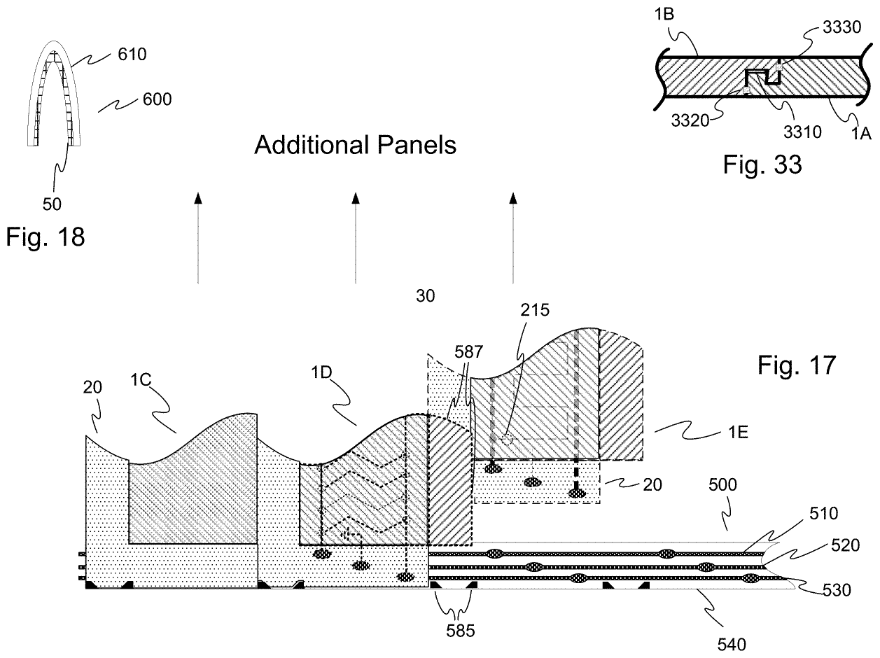

In certain optional embodiments it is desired to locate heating panels in specific locations along the connector bar. By way of example this is desired in designs where contacts in the heating elements are to mate with contacts in specific locations along the connector bar. To ease such alignment matching keys 587, 585 may be provided on the connector bar 500 and the panel 1 respectively, as shown by way of example in FIG. 17.

FIG. 17 is a top view of a section of the connector bar 500 and the end zone of a plurality of heating panels 1C, 1D, 1E to demonstrate an optional connection method of the panels to the connector bar 500. Portions of panels 1C and 1D are shown already in the operational position while the portion of panel 1E is shown aligned to be placed. Panel 1C is shown opaque while panels 1D and 1E are depicted with a level of transparency that facilitates understanding of the internal components of the hating panels and their interaction with the complete floor system. For demonstration purposes panel 1D is constructed with chevron type heating element 100 while panel 1E is shown with a resistive a single wire or pattern heating element and with the optional switching device 215. Any, all, or none of the panel may incorporate the switching devices 215 or the severable link 200, and any panel may utilize any type of heating element 100, and any of the optional features as appropriate for specific requirements. As seen by the arrows, additional panels are connected to the panels that are fed by the connector bar, and the additional panels are fed via the busbars of the panels in contact with the connector bar.

Optionally, a connector bar 500 may be field trimmed to any desired length.

In certain systems it is desired to supply at least some of the heating panels in varying lengths, to allow a more natural look of the finished floor by avoiding a hatched lines separating individual panels. Furthermore, room geometry commonly dictates trimming panel dimensions, and commonly it is desired to perform such trimming in the field. One common place for such trimming requirement is terminating a row of panels at a side of the room opposite the connector bar. In order to facilitate insulation of powered components from the like of liquid spills and the like, a sealing bar may be provided. Such sealing bar may have numerous forms, and the skilled in the art would recognize numerous methods to seal the cut end of the panel and electrically insulate powered elements therein. A simplified example of such insulation bar 600 is shown in FIG. 18 and comprises a shall 610 with an adhesion zone 50. The bar is placed, and thus adhered, to the end of the heating panel terminating a row of connected heating panels, and sealing the panel's end.

It is noted that the drawings provide contacts on the abutment along the short side of rectangular panels, however such placement of the contacts is not mandated contacts may be placed on the elongated side abutment. In panels of rectangular top surface placement of the contacts on long v. short end abutment is irrelevant, and contact placement may be selected as desired for various polygonal shape panels. Moreover, optionally contacts may be disposed on more than two abutments, at any desired arrangement. Thus, by way of non-limiting example, contacts may be disposed on the long edge abutments as well as on the short edge abutments, and respective contacts may be cross connected such that feeding of power is enabled from one short edge to its opposite short-edged side, as well as to one or more long edges of a single panel. Such arrangement (not shown) may be utilized to feed a first panel residing in a row, and a second panel attached to the long edge of the first panel.

FIG. 19 depicts two sections of connector bars 500A and 500B respectively, showing several optional features.

FIG. 19 depicts an extension adapter 1910 which is disposed between two sections of connector bar 500A and 500B respectively, permitting mutual coupling of two connector bars, and an optional mid-bar power feed. FIG. 20 depicts an enlarged view of the optional extension adapter 1910. Adapter 1910 comprise an abutment 540A and a plurality of conductors 1927 coupling between matching connector bar couplers 1930 disposed on opposing ends of the adapter. Optionally conductors 1927 comprise a plurality of busbars similarly disposed as the plurality of busbars of the connector bars 500A and 500B.

FIG. 21 depicts a cross-section of extension adapter 1910 along section line Q-Q of FIG. 19. Each of two opposing ends of the extension adapter comprise a connector bar coupler 1930A and 1930B respectively. The skilled in the art would recognize numerous suitable methods of forming a connector bar coupler 1930 for providing at least electrical coupling between the busbar and the adapter, and optionally provide mechanical coupling as well. By way of example pins may be provided on one of the connector bar or the adapter and cooperating sockets on the opposing member. Cooperating contact surfaces may be utilized for providing a connector bar coupler, if mechanical coupling is also utilized. By way of non-limiting example, adapter pins 1925A, 1925B, and 1925C are shown extending beyond the body of the adapter 1910, to fit matching cavities in the respective connector bar 500A or 500B. An alternative method of connecting two connector bars is by having matching connector bar couplers on the connector bars themselves. In some embodiments pin and socket arrangement are used for the connector bar couplers, while in some embodiments the connector bar coupler may comprise sockets on both operationally adjacent connector bars with conductive pins being inserted to adjacent sockets on both connector bars. It is noted that the connector bar couplers on both sides of the adapter may be similar or different, and similar matching arrangements may be utilized for various adapters. Preferably, the connector bar and/or any adaptors utilize sealing zones to operationally seal inter-connector contacts.

FIG. 19 also depicts an optional connection method of power supply to the connector bar. Conductors 1920 are coupled to respective adapter conductors 1927 which are utilized to feed power to the connector bar(s). Moreover, an extension adapter with a single connector bar coupler provided only on one side of the adapter may be utilized as an end power feed adapter. In embodiments where the conductors 1927 are formed as busbar sections, the wires 1920 may be coupled to the busbar sections. It is noted that the wires may be of any convenient construction, including, if desired flat cable construction. Flat cable construction may be beneficially utilized to connect a plurality of connector bars which are not easily connectable directly. By way of example, certain structures or objects may be disposed away from the walls of a room, such as a kitchen ‘island’. Laying connector bars on the wall and on a side of the island away from the wall may be advantageously achieved by a routing a flat cable extending under the floor from the connector bar and/or connector bar couplers, or even from a direct feed such as a thermostat or a relay.

In order to accommodate thermal expansion and construction of the floor, a spacing is desired between the floor edge and the adjacent wall or other structure. Optionally the connector bar is constructed to enforce such spacing by adding a resilient spacer 565 disposed on the side of the connector bar 500 opposite the side from which the heating panels extend. Such resilient spacer may comprise solid compressible material such as foam or rubber, or be formed as a spring or honeycomb form such as shown by way of example in FIG. 23. Further optionally a spacer may be provided on the insulation bar 600 (not shown).

FIG. 22 depicts an angle adapter 2210 which allows coupling two connector bars at an angle. The angel adapter comprises an angled body 540B with a connector bar coupler 1930A and 1930B at respective ends of the adapter body, to couple each of the edges to respective connector bars. Angle adapters may be formed in any desired angle, including by way of example inside corner and outside corner adapters at 90°, 45, 30° and the like.

FIG. 23 depicts another optional arrangement for a connector bar, FIG. 24 depicts a bottom view of an end section of a heating panel designed to couple to the connector bar of FIG. 23, and FIG. 25 depicts a flattened cross-section side view of a portion of a heating panel being coupled to the connection bar of FIG. 23. FIG. 23 also depicts an embodiment of spacer 565 formed as a honeycomb.

FIG. 23. Depicts an optional configuration of a connector bar 500 composed of a lower layer 500L upon which a plurality of conductors is laid. In the depicted example the conductors are busbars 510, 520 and 530, extending in parallel along the connector bar. An upper layer 500U is laid over at least a portion of the lower layer 500L, forming together the abutment of the connector bar. In the example depicted by FIG. 23 the left side portion marked 500L is shown without the upper layer 550U, for illustrative purposes. Preferably the upper layer 500U is made of insulating material, however an upper layer may be made of a plurality of sublayer, some conductive and some insulating. The upper layer has a plurality of cavities 2520 disposed over contacts on the lower layer 500L. In the depicted embodiment the cavities are formed to overlay the busbars, but in other embodiments the conductors are electrically coupled respective contacts which underlie the cavities in predetermined arrangement such that operatively conductors would be electrically coupled to corresponding elements of the heating panels connected to the connection bar. At the bottom of the upper abutment 20 of a matching heating panel a plurality of protrusions 2510 are disposed so as to cooperate with the cavities of upper layer 500U. Contacts are disposed at the end of the protrusions. As seen in FIG. 25 when the heating panel 1 is mated with connector bar 500 the protrusions 2510 are disposed within the cavities 2510, and the contacts such as 140, 160 and 170 contact the busbars 510, 520, and 530, or other contacts at the bottom of respective cavities, forming electrical communication where energy may be fed to the heating panel(s). Clearly the arrangement may be reversed where the panel comprises cavities and the protrusions extend from the connector bar abutment, as well as mixed arrangements where a number of cavities and protrusions are disposed on the connector bar and cooperating cavities and protrusions are disposed on the heating panel. It is noted that for clarity, no wiring is depicted between the contacts such as 140, 160, 170 and relevant panel components in FIG. 25.

The arrangement of cavities and protrusion enables higher contact density when desired. Furthermore, the cavities and protrusion simplify the arrangement if non-staggered contact arrangement is desired.

The connector bar may utilize any abutment to fit the heating element which will operationally connect to it, such as a tongue and groove type and/or mechanical interlocking type abutment, where the abutment portion of the connector bar is made to fit the respective heating panel to which it connects.

As mentioned above power supply to a floor panel may be single phase or multi-phase. In the case of multi-phase system with heating panels that use only a single phase and the connector bar is configured to provide different phases to different panel rows. Power may be fed by contacts disposed on the abutments along the short and/or long edges of the panel top surface, and abutments may be discontinuous.

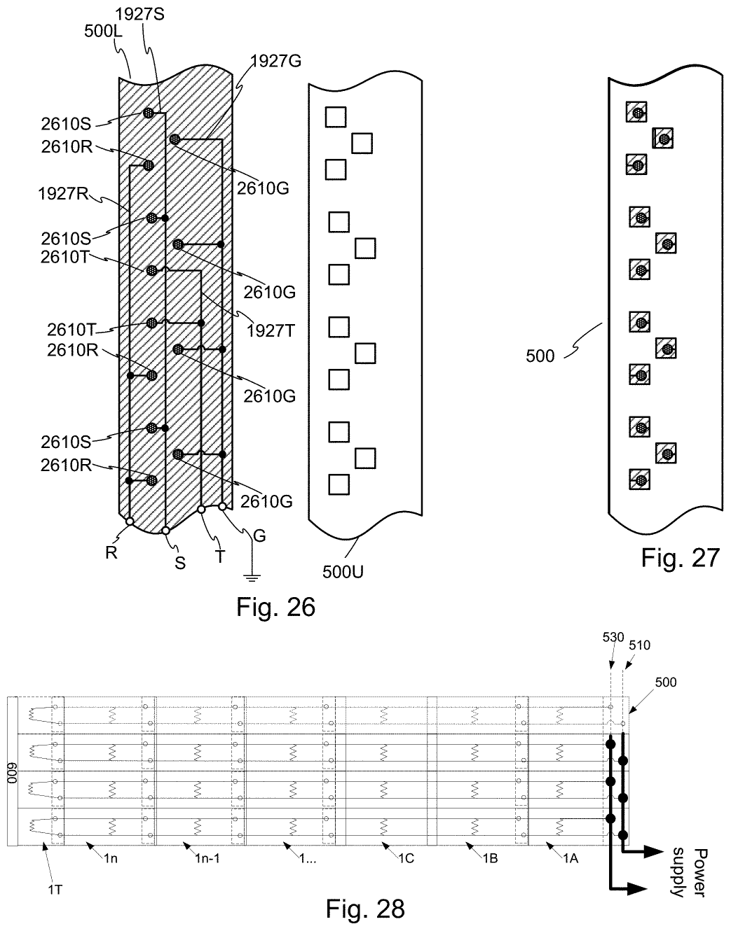

FIG. 26 depicts side-by-side sections of an upper 500U and lower 500L layers of an exemplary connector bar for three-phase powered floor. The upper and lower layers are laid at an offset to facilitate understanding of the inner structure of the three-phase connector bar 500 shown in FIG. 27.

As is common in other embodiments of connector bars, the lower layer 500L of a three-phase connector bar is made of insulating material. Wires 1927 and contact electrodes 2610 are laid on the lower layer 500L to facilitate connection. As seen in FIG. 26 three phase terminals are depicted, namely R, S, and T, as well as a ground terminal G. Notably the terminals depicted are merely symbolic as connection of wires to the connector bar may be embodied in numerous fashions as described herein, and as only a short section of the connector bar is depicted. Conductors, generally enumerated 1927 are shown with a letter indicating their electrical affiliation, connect the ‘terminals’ to contact electrodes generally enumerated 2610 with similarly adjoining letters. The contact electrodes are grouped to supply each heating panel row attached to the connector bar with three phases, a neutral, and ground. The upper layer 500U in the depicted example is also composed of insulating material, and is provided with cavities to match the contact electrodes. FIG. 26 depicts a simplified wiring diagram which feeds power to each adjacent panel row from differing two phases, improving equal phase loading. FIG. 27 depicts a top view of the section of the connector bar of FIG. 26. The contact electrodes are seen through cavities in top layer 500U.

FIG. 28 depicts a simplified schematic diagram of how a floor is laid utilizing a connector bar 500, having two busbars 510 and 530. Once the connector bar is laid a first heating panel 1A is laid such that contacts on its upper abutment 20 engages contacts in the connector bar 500. Then a second heating panel 1B is laid such that contacts at its top abutment 20 engages contacts at the lower abutment 30 of the previously laid panel 1A. The process continues when panel 1C engages panel 1B, and so forth, until panel in (n being any integer). It is common that the required floor dimensions are not an integer multiple of panels and a shorter termination panel 1T is required. Such panel may be pre-supplied or cut during floor installation from a full length panel. While connecting the respective abutments of panel 1n and 1T is done in a similar fashion to the previous panels, the end of panel 1T further from 1n may pose a danger as it allows electrical power to reach a non-insulated end. Two solutions are provided for that problem: the first solution involves disconnection of the panel 1T from power prior to engagement of the lower abutment of panel 1n, and the other solution involves applying an insulation bar 600 to the shortened end of the terminating panel 1T.

Once the first row of heating panels is laid floor formation continues by laying additional rows of heating panels, until the desired floor surface is covered by heating panels. Connecting power to the busbars 510 and 530 energizes the floor. Installing insulation bar 600 may be done for individual rows or for the ends of a plurality of rows after the rows are laid.

Notably thickness differences between layer(s) above or below the heating element of a panel are possible in all embodiments, and either the upper or the lower layer may be thicker. Furthermore the upper and lower layers may be of different materials and even a single layer may comprise a plurality of layers. By way of example the layer above the heating element may comprise any or all of an initial insulation layer, ground plane, a protective layer of higher mechanical strength, a decorative layer to provide the desired aesthetic appearance of the panel, a wear resistant coat, and the like. Similarly the layer below the heating element may comprise an insulation layer, a mechanical strength layer, a sound insulating layer and the like.

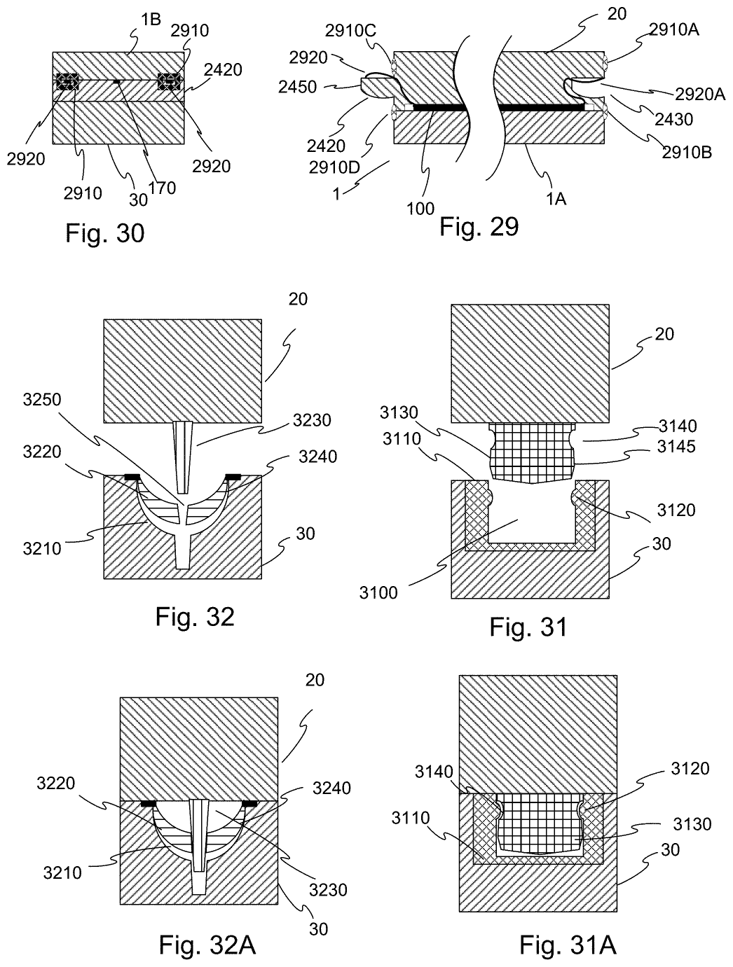

FIGS. 29 and 30 depict schematically an embodiment utilizing tongue and groove abutments. In many of the embodiments described above the flat adhesive type abutment may be replaced by tongue and groove abutment types. FIG. 29 depicts a long side view (shown truncated), while FIG. 30 depicts a short side view of the end abutment, and both are shown in cross-section to show elements of the inter-panel connection area, such as contact placement and the sealing zone protecting the contacts. The side abutments of several previously described embodiments are replaced by the tongue 2420 and groove 2430 arrangement. A substantially matching tongue and groove are utilized to connect consecutive panels and provide electrical connection therebetween. The heating panel 100, busbar arrangement and the optional ground plane are generally similar to any other embodiment disclosed hereinabove. The contacts, depicted in FIG. 29 as 2920 and 2920A are disposed on the tongue and groove portion respectively in any convenient disposition which will provide contact registration of two operationally connected adjacent panels. Such contact may be advantageously formed of spring metal however all other contact forms are acceptable as long as the contacts meet design criteria such as low resistance, current carrying capacity, contact quality and the like. Contacts on the tongue and the groove are provided substantially in registration when a pair of consecutive panels are operationally coupled, or stated differently the contacts are disposed to electrically engage each other when two heating panels under operational conditions, in a manner similar to the one described for other embodiments.

Sealing the contacts in a tongue and groove based abutments may be achieved by disposing sealing zones about the contacts. One such way is disponing sealant bids 2910 A-D to form sealing zone 2910 about the contact 2920, 2920A when the adjacent heating panels are engaged, as can be seen by way of example in FIG. 30. As in the case of other embodiments the sealing zones may be disposed on one or both of the panels, in any convenient manner. By way of example, applying sealant to the groove area eases sealing the sides of the contact region provides better protection for the sealant, while applying sealant to the top and/or bottom of the contact region may be easily achieved in either the tongue or the groove. Dual materials may be deployed, such as epoxy sealant, where one part of the epoxy may be deployed to the tongue portion and the other epoxy part may be deployed in the groove portion. Furthermore, pockets may be formed about the area where sealant is disposed to allow better retention of the sealant. Protective covering is desired for shipping the heating panels. It is noted that by merely inclining one panel's tongue into engagement with the groove of such panel both the electrical connection and the environmental protection of the connection is achieved.

Certain tongue and groove arrangements are based upon resilience of the tongue and groove regions, and require certain insertion force, however the panel construction described does not significantly change.

Contacts may be of any desired construction. In an optional construction especially befitting tongue and groove base abutments the contacts may be of spring metal. Matching contacts of such systems may be single sided as shown by way of example in FIG. 29, or dual sided, whereby contacts are disposed on the upper and lower side of the tongue and groove. In optional embodiments the contact may reside on the face 2450 of the tongue and on a matching location within the groove. In certain embodiments one contact of the pair of contacts of the abutment may be disposed on the upper portion of the tongue, while the second contact of the pair resides on the lower portion, each with perspective contact within the groove.

Other panel attachment arrangements known in the flooring art may be utilized. Notably, the connector bars described may be easily adapted to the tongue and groove based abutments by modifying the abutment described in FIGS. 15, 17, 19, and others by modifying the abutment by adding either a tongue or a groove and contact disposition to match the complementary heating panel end to be coupled to the connector bar.

FIG. 31 depict schematically one optional construction of a snap type matching contact, where the two parts of the contact are aligned and ready to be mutually engaged, and FIG. 31A depicts the two contact parts engaged. The contact comprises a stud 3130 coupled to an abutment of one layer of a heating panel to be connected to the another, which is depicted by way of example to the top layer 20. The stud cross-section may be round, square, rectangular or any desired geometrical shape, and elongated shapes generally allow higher current carrying capacities. Optionally stud 3130 has a groove portion 3140, where the stud portion below the groove portion is larger in the diameter or in a width dimension than the corresponding groove dimension. A matching socket 3110 having a cavity 3100 is disposed on abutment of the lower layer 30 of an opposing heating panel. The cavity 3100 is dimensioned to receive the stud or a portion thereof. Optionally a neck 3120 matching at least in part the groove portion 3140 of stud 3130 is provided within the socket structure. The neck is dimensioned to resiliently engage the stud groove, as may be seen in FIG. 31A. In certain embodiments the neck 3120 comprises one or more springs. It is noted that the neck and the groove are both optional, and the stud/socket may interface and be held by the adhesive forces between the relevant abutments. Optionally, the socket 3110 comprises a plurality of portions that are operationally resiliently urged towards the stud 3130.

Yet another optional contact arrangement is depicted in FIGS. 32 and 32A. FIG. 32 depict schematically one optional construction of a snap type contact, where the two parts of the contact are aligned and ready to be mutually engaged, and FIG. 32A depicts the two contact parts engaged. The contact comprises an member having a blade 3230 coupled to an abutment of one layer of the a heating panel to be connected to another, which is depicted by way of example to the top layer 20. The blade lateral cross-section may be round, square, rectangular or any desired geometrical shape, and the depicted taper is optional. A matching socket 3210 is disposed on abutment of the lower layer 30 of an opposing heating panel. The socket 3210 comprises one or more resilient plates 3220, 3240 which are split at a gap 3250. Upon insertion of the blade 3230 to the gap 3250, the resilient plates 3220 and 3240 impart a force to the blade, providing electrical contact and applying holding force to the blade to prevent disengagement of the male and female contacts. The resilient plates may be flat or concave as depicted in FIGS. 32 and 32A. FIGS. 32 and 32A, and optionally the embodiment depicted in FIGS. 30 and 30A depict but two of numerous embodiments when a member of one side of the matching contacts, such as stud 3130 or blade 3230 (when utilizing the optional groove and neck arrangement) displaces a member of the opposite side of the matching contact (socket).

It is noted that the contact orientation may be reversed, such that the contact part described as coupled to the upper portion of the panel 20 may be coupled to the lower portion 30, and vice versa. The contact material, or at least a portion thereof, is conductive.

FIG. 33 depicts a simplified schematical cross-section of the connection region between two heating elements 1A, 1B utilizing mechanical interlocking abutment type. The structure is but one example of numerous available mechanical interlocking arrangement which are applicable to embodiments of the invention. It is noted that the contact 3310 is shown in only one of several faces of the interlocking abutment and the invention extends to other locations. Furthermore, any type of contact may be utilized. Similarly, the sealing zones 3320 and 3330 are shown in exemplary location only and may be moved as desired. By way of example the sealing zones may be localized about the contact or extend to cover a plurality of contacts, or even extend throughout the length of the abutment.

In all embodiments, the top and bottom layers may be constructed of any desired material, such as plastic, wood, layers of wood and/or plastic venire, ceramic material and the like. If insulated material is utilized to isolate the power carrying elements from the surrounding non-powered elements, metallic and other conductive materials may be used. Furthermore in some embodiments the lower layer may be resilient in order to conform to imperfection in the sub-floor on which the flooring panel is laid. Either one of the layers may be made of similar or dissimilar materials. Furthermore in some embodiments each of the layers may be constructed of several sub layers. By way of example the bottom layer may comprise a lower sub-layer which is sufficiently pliant to accommodate subfloor irregularities, and a strong protective sub-layer to protect against penetration by a lower protrusion. Similarly a protective sub-layer may be disposed in the upper layer to protect against penetration from the top. Fibrous or solid materials may be utilized for such protective layers.

The terms panel, plank, and tile are used interchangeably to indicate a heating panel member. The terms sealant, glue and adhesive are also used interchangeably.

Notably, adhesion zones may be utilized in any location on the complementary abutments, in a tongue and groove, flat or slotted—overlap abutments. It is common to apply adhesive/sealant on both of the opposing sides, however adhesive/sealant may be applied to only one of the mating surfaces and the application of the adhesive is a matter of design choice. While the invention has been described so far in terms of adhesive/sealant being pre-applied to adhesion/sealing zones, in the case of flat abutment adhesive may be applied at the time of assembly of the floor. The term adhesion zone and or sealant zone extends equally to areas upon which adhesive are applied, whether to a single surface or to both opposing surfaces of the abutments which form the joint, as well as to the resulting area of adhesive formed after the complementary abutments are joined. Furthermore, an adhesion zone should be construed to include an area in which the adhesive acts as a sealant as well as an area where a portion of the area utilizes only a sealant and another only adhesive, and vice versa. An area were a sealant acts as an adhesive between the mating surfaces is also an embodiment of an adhesion zone. In many embodiments the adhesion zone is formed of a combination of two adhesion zone each on a surface, and the adhesion zone of each is formed when the two adhesion zones are brought together and adhered to each other.

It is further noted that while the terms complimentary and substantially complementary are used herein interchangeably, the terms complementary and substantially complementary as relating to abutments, denote an upper and a lower abutments of two adjacent floor panels respectively, the abutments are brought together to form the floor surface, and the complementary nature of the abutment may include any arrangement which will result in substantially flat floor. Such substantially complementary abutments do not necessarily match each and every feature of each other in a completely complementary manner. Thus, by way of example a flat abutment surface may be mated with a slotted abutment surface as well as with another flat surface, and one single protrusion abutment may be mated with a complementary abutment having a plurality of slots if there is at least one slot matching the protrusion. The complementary nature of the abutments may be made within reasonable tolerances selected to enable the jointing of adjacent floor panels, and when applicable to provide the required electrical contact requirements, as considered against other design considerations. When relating to contacts, the term complementary or substantially complementary relate to an arrangement where contacts are brought together to form electrical continuity when respective abutments are brought together in matched face to face relation to form a substantially flat floor surface, in matching fashion such that by way of example by laying floor panels in a continuous fashion where a first panel upper abutment is disposed above the lower abutment of a second panel and such that the respective contacts are in substantial registration sufficiently to create an electrical contact between matching contacts and/or electrodes.

The term “flattened cross-section” implies that the depth dimension is largely ignored, depth in this context being along the elongated axis of the connector bar. Thus while contacts 140, 160, and 170 may be staggered depth-wise, they are shown on a single ‘flattened’ plane.

The term ‘operational’ and its variations (such as “operationally” by way of example), when applied to a completed floor or to portions thereof such as individual heating panels, connector bars, and the like, when the floor or the portion thereof are laid in their intended arrangement and are ready to receive and/or receiving electrical power. Two adjacent heating panels or a heating panel and/or a heating panel and a connector bar should be construed as operational when the elements are laid interconnected and being in electrical communication therebetween, and/or receiving electrical power.

As is common in patent drawings the drawings and portions thereof are not necessarily drawn to any scale, neither between drawings nor within a single drawing. By way of particular example, adhesion zones may be very thin and depictions thereof in the drawings are highly exaggerated. Some of the drawings reflect only specific portion of the heating panels while other drawings and the accompanying description clarify the relative disposition of such portions.

While for brevity the description above relates to floor panels, it is noted that heating panels, connector bars, and adapters may be utilized as wall panels and/or ceiling panels.

The skilled in the art would recognize that busbars and contacts are at least in parts electrically conductive.

While for brevity, the figures and the associates description generally describe a floor panels utilizing a rectangular top surface by way of example, it is noted that floor panels may be provided with top surfaces in any desired geometrical form such as, by way of example, square, rectangle, chevron, triangle and other polygons, and the scope of panel claims extend to such configurations. Furthermore, the heating panels disclosed herein may also be installed as a wall covering or even a ceiling if desired.

While certain embodiments may achieve one or more of the stated objects, persons skilled in the art would recognize that various embodiments may achieve one or more of those goals to a higher or lesser extent, and some embodiments may not achieve one or more goals, yet fall within the scope of the invention.

Unless otherwise specified, relational terms used in these specifications should be construed to include certain tolerances that the skilled in the art would recognize as providing equivalent functionality. By way of example the term perpendicular is not necessarily limited to 90.0°, but also to any slight variation thereof that the skilled in the art would recognize as providing equivalent functionality for the purposes described for the relevant member or element. Terms such as “about” and “substantially” in the context of configuration relate generally to disposition, location, or configuration that is either exact or sufficiently close to the location, disposition, or configuration of the relevant element to preserve operability of the element within the invention which does not materially modifies the invention. Similarly, unless specifically specified or clear from its context, numerical values should be construed to include certain tolerances that the skilled in the art would recognize as having negligible importance as it does not materially change the operability of the invention.

In these specifications reference is often made to the accompanying drawings which form a part of the disclosure, and in which are shown by way of illustration and not of limitation, exemplary implementations and embodiments. Further, it should be noted that while the description provides various exemplary embodiments, as described below and as illustrated in the drawings, this disclosure is not limited to the implementations described and illustrated herein, but can extend to other embodiments as would be known or as would become known to those skilled in the art. Reference in the specification to “one embodiment”, “this embodiment”, “these embodiments”, “several embodiments”, “selected embodiments” or “some embodiments” means that a particular feature, structure, or characteristic described in connection with the embodiment(s) may be included in one or more implementations, and the appearances of these phrases in various places in the specification are not necessarily all referring to the same embodiment(s). Additionally, in the description, numerous specific details are set forth in order to provide a thorough disclosure, guidance and/or to facilitate understanding of the invention or features thereof. However, it will be apparent to one of ordinary skill in the art that these specific details may not all be needed in each implementation. In certain embodiments, well-known structures, materials, circuits, interfaces have not been described in detail, and/or may be illustrated schematically or in block diagram form, so as to not unnecessarily obscure the disclosure.

For clarity the directional terms such as ‘up’, ‘down’, ‘left’, ‘right’, and descriptive terms such as ‘upper’ and ‘lower’, ‘above’, ‘below’, ‘sideways’, ‘inward’, ‘outward’, and the like, are applied according to their ordinary and customary meaning, to describe relative disposition, locations, and orientations of various components. When relating to the drawings, such directional and descriptive terms and words relate to the drawings to which reference is made. Notably, the relative positions are descriptive and relative to the above described orientation such as an upright orientation and modifying the orientation would not change the disclosed relative structure.

To the extent necessary to understand or complete the disclosure of the present invention, all publications, patents, and patent applications mentioned herein, including in particular the applications of the Applicant if any, are expressly incorporated by reference in their entirety by reference as is fully set forth herein.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

I claim:

1. a heating panel comprising:
a polygonal body having at least a first and a second opposing abutments, a top and bottom surfaces separated by a panel thickness;
at least a pair of electrical busbars extending between the first and second abutments;
at least one electrical heating element disposed between the top surface and the bottom surface; the heating element being directly or indirectly electrically coupled between the busbars for receiving electrical energy therefrom;
a first pair of electrical contacts disposed in or about the first abutment;
a second pair of electrical contacts disposed in or about the second abutment, the first and second contact pairs being disposed on their respective abutments in substantially complementary position, each contact in the first pair of contacts being electrically coupled by a respective busbar of the pair of busbars to a contact in the second pair contacts; and,
a sealant disposed on or about at least one of the abutments to operationally form at least one sealant zone adjacent to at least one contact of the pair of contacts of the respective abutment, the sealant being disposed so as to limits fluids from reaching the respective contact.

2. The heating panel as claimed in claim 1, further comprising:
An electrical ground plane disposed at least between the heating element or a portion thereof and the top surface;
at least a first ground electrical contact disposed on or about the first abutments; and,
a second ground contact disposed on or about the second abutment in substantially complimentary position, the first and second ground contacts being electrically coupled to the ground plane.

3. The heating element as claimed in claim 1, wherein one contact of the first or second pairs of contacts is a male contact and wherein a second, complementary positioned contact disposed on the abutment opposing the abutment upon which the male contact is disposed, is a female contact, the male and female contacts being constructed such that when a pair of heating elements are operationally laid end to end, the female contact of one heating element will mechanically engage the male contact of the other heating element, the engaged male and female forming a matching contact pair and providing an electrical connection between the pair of heating elements.

4. The heating element as claimed in claim 3, wherein the male contact comprises a pin or a blade, and wherein the female contact comprise a socket dimensioned to receive the male contact.

5. The heating element as claimed in claim 3, wherein the female and male contacts operationally engage each other by resilient force.

6. The heating element as claimed in claim 3, wherein the male contact comprises a blade and the female element comprising at least one resilient member capable of operationally applying mechanical force to the blade, the mechanical force being directed to prevent disengagement of the male and female contacts.

7. The heating element as claimed in claim 3, wherein either of the male and the female contacts comprises electrically conductive and non-conductive elements.

8. The heating element of claim 1, wherein the first and second abutments comprise a tongue and grove arrangement.

9. The heating element as claimed in claim 1, wherein the first and second abutments are of flat overlapping and/or of slotted overlapped design.

10. The heating element as claimed in claim 1 wherein the first and second abutments are of mechanical interlocking design.

11. The heating element as claimed in claim 1 wherein the sealant comprises a first and second sealant parts, the first part being disposed on the first abutment and the second part being disposed on the second abutment.

12. The heating panel as claimed in claim 10, wherein the first sealant part and the second sealant part are of differing chemical composition.

13. The heating panel as claimed in claim 1, wherein the heating element comprises a plurality of sub-elements connected in parallel.

14. The heating element as claimed in claim 1, further comprising a severable link electrically coupled in series with the heating element.

15. The heating panel as claimed in claim 1, further comprising a switch electrically coupled in series with the heating element.

16. The heating element as claimed in claim 15, wherein the switch is magnetically operated.

17. The heating element as claimed in claim 1, wherein the sealant zone operationally provides compressive force, for urging opposing contacts against each other.

18. The heating element as claimed in claim 1, further comprising at least one mechanical protection layer.
